(19) United States
(12) Patent Application Publication
(10) Pub. No.: US 2026/0370390 A1
(43) Pub. Date: Nov. 19, 2026

(54) ENHANCEMENT FOR DYNAMIC GRANT OVERRULING A CONFIGURED GRANT

(71) Applicant: Apple Inc., Cupertino, CA (US)

(72) Inventors: Ralf ROSSBACH, Munich (DE); Ping-Heng KUO, London (GB); Fangli XU, Beijing (CN)

(21) Appl. No.: 19/126,225

(22) PCT Filed: Nov. 1, 2022
(86) PCT No.: PCT/CN2022/129005

§ 371 Date: Apr. 30, 2025

(51) Int. Cl. H04L 1/1812; H04L 5/00; H04W 72/51; H04W 72/563

(52) U.S. Cl. CPC H04L 1/1812; H04L 5/0044; H04L 5/0053; H04W 72/51; H04W 72/563

(57) ABSTRACT

User equipment (UE) in a 5G new radio (NR) environment may be configured to perform operations. In response to receiving a dynamic uplink grant (DG) that indicates a HARQ process that is associated with a configured uplink grant, the UE may start or restart a configured grant timer that is associated with the HARQ process, wherein the configured grant timer restricts access to the HARQ process when the configured grant timer is running. The UE may transmit a physical uplink shared channel (PUSCH) message associated with the DG, using the HARQ process. In response to receiving a HARQ acknowledgement of the PUSCH message associated with the DG and in response to the HARQ process being associated with a configured uplink grant (CG), the UE may stop the configured grant timer.

### FIELD OF INVENTION

This invention relates generally to wireless technology and more particularly to communications involving a dynamic uplink grant (DG) and a configured uplink grant (CG).

### BACKGROUND OF THE INVENTION

Fifth generation mobile network (5G) is a wireless standard that aims to improve upon data transmission speed, reliability, availability, and more. The wireless standard includes numerous procedures that may be implemented by a transmitting device or a receiving device that improves the latency, the speed, and the reliability of uplink and downlink transmissions.

### SUMMARY OF THE DESCRIPTION

Aspects of the present disclosure relate to 5G new radio (NR) operating in the licensed spectrum or in the shared and unlicensed spectrum (NR-U).

In some aspects, a user equipment (UE), may have a processor that is configured to perform operations described. In response to receiving a dynamic uplink grant (DG) that indicates a HARQ process that is associated with a configured uplink grant, the UE may start or restart a configured grant timer that is associated with the HARQ process. The configured grant timer restricts access to the HARQ process when the configured grant timer is running. The UE may transmit a physical uplink shared channel (PUSCH) message associated with the DG, using the HARQ process. In response to receiving a HARQ acknowledgement of the PUSCH message associated with the DG and in response to the HARQ process being associated with a configured uplink grant (CG), the UE stops the configured grant timer. As a result, the HARQ process may be made available for new data transmissions over CG PUSCH.

In some aspects, the HARQ acknowledgement may be received in the form of a toggled new data indication (NDI) bit, which may indicate the acknowledgement, but may also indicate initiation of a new DG. In response to receiving the HARQ acknowledgement as the toggled new data indication, the UE may restart the configured grant timer for the HARQ process in response to determining that a new DG satisfies one or more utilization criteria. Further, the UE may not restart the configured grant timer for the HARQ process in response to determining that the new DG does not satisfy the one or more utilization criteria of the new DG.

In some examples, the one or more utilization criteria may be satisfied in response to satisfying logical channel prioritization (LCP) mapping restrictions of the new DG. Additionally, or alternatively, the one or more utilization criteria may be satisfied in response to logical channels associated with the CG being capable of being multiplexed on the new DG. Additionally, or alternatively, the one or more utilization criteria may be satisfied in response to data being available for one or more logical channels that are mapped to the new DG. Additionally, or alternatively, the one or more utilization criteria may be satisfied in response to data being available for one or more logical channels that are mapped to the CG wherein the data is eligible to be mapped to the new DG.

In such a manner, the UE determines if the new DG can or cannot be utilized. If it can be utilized, the CG timer is restarted so that the HARQ process associated with that CG timer is reserved for the new DG. Otherwise, the CG timer is not restarted so that the HARQ process is available for transport (e.g., for CG PUSCH messages).

In some aspects, a method can be performed by the UE in a NR environment. In some aspects, a baseband processor can be configured to perform the methods described. The baseband processor can execute instructions stored in a computer readable medium (e.g., one or more computer programs) to perform such methods.

Other aspects are also described.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to some aspects.

FIG. 2 illustrates uplink and downlink communications according to some aspects.

FIG. 3 illustrates an example block diagram of a UE according to some aspects.

FIG. 4 illustrates an example block diagram of a BS according to some aspects.

FIG. 5 illustrates an example block diagram of cellular communication circuitry, according to some aspects.

FIG. 6 illustrates a general example of a HARQ process performed by a UE, in accordance with some aspects.

FIG. 7 shows an example of a HARQ process with a DG override, in accordance with some aspects.

FIG. 8 shows an example of a HARQ process with a DG override, in accordance with some aspects.

FIG. 9 shows an example of a method for management of a HARQ process in view of a DG override, in accordance with some aspects.

FIG. 10 shows an example workflow of a HARQ process and new data indication, in accordance with some aspects.

### DETAILED DESCRIPTION

A method and apparatus of a device that determines a physical downlink shared channel scheduling resource for a user equipment device and a base station is described. In the following description, numerous specific details are set forth to provide thorough explanation of aspects of the present invention. It will be apparent, however, to one skilled in the art, that aspects of the present invention may be practiced without these specific details. In other instances, well-known components, structures, and techniques have not been shown in detail in order not to obscure the understanding of this description.

Reference in the specification to “some aspects” or “an aspect” means that a particular feature, structure, or characteristic described in connection with the aspect can be included in at least one aspect of the invention. The appearances of the phrase “in some aspects” in various places in the specification do not necessarily all refer to the same aspect.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device may provide enhanced operation for situations where a dynamic grant may overrule a configured grant. In some aspects, the device is a user equipment device that has a wireless link with a base station. In some aspects, the wireless link is a fifth generation (5G) link.

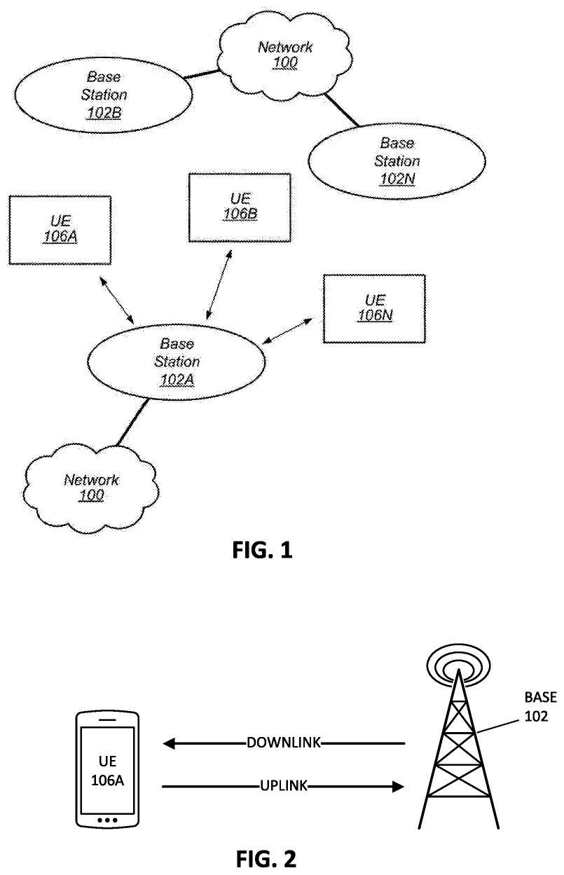

FIG. 1 illustrates a simplified example wireless communication system, according to some aspects. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to as a “user equipment” (UE).

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some aspects, base station 102A may be a next generation base station, e.g., a 5G New Radio (5G NR) base station, or “gNB”. In some aspects, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

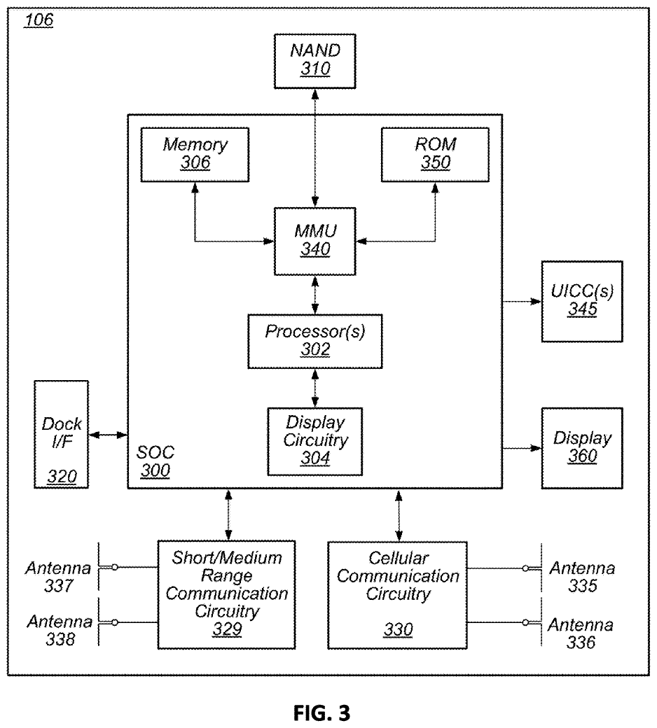

FIG. 2 illustrates UE 106A that can be in communication with a base station 102 through uplink and downlink communications, according to some aspects. The UEs may each be a device with cellular communication capability such as a mobile phone, a hand-held device, a computer or a tablet, or virtually any type of wireless device.

The UE may include a processor that is configured to execute program instructions stored in memory. The UE may perform any of the method aspects described herein by executing such stored instructions. Alternatively, or in addition, the UE may include a programmable hardware element such as an FPGA (field-programmable gate array) that is configured to perform any of the method aspects described herein, or any portion of any of the method aspects described herein.

The UE may include one or more antennas for communicating using one or more wireless communication protocols or technologies. In some aspects, the UE may be configured to communicate using, for example, CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE may include separate transmit and/or receive chains (e.g., including separate antennas and other radio components) for each wireless communication protocol with which it is configured to communicate. As a further possibility, the UE may include one or more radios which are shared between multiple wireless communication protocols, and one or more radios which are used exclusively by a single wireless communication protocol. For example, the UE might include a shared radio for communicating using either of LTE or 5G NR (or LTE or 1xRTT or LTE or GSM), and separate radios for communicating using each of Wi-Fi and Bluetooth. Other configurations are also possible.

FIG. 3 illustrates an example simplified block diagram of a communication device 106, according to some aspects. It is noted that the block diagram of the communication device of FIG. 3 is only one example of a possible communication device. According to aspects, communication device 106 may be a UE device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some aspects, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some aspects, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short-range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short-range wireless communication circuitry 329 may include one or more ICs that are configured to perform the functions of short-range wireless communication circuitry 32. In addition, each integrated circuit may include circuitry (e.g., first circuitry, second circuitry, etc.) configured to perform the functions of short-range wireless communication circuitry 329.

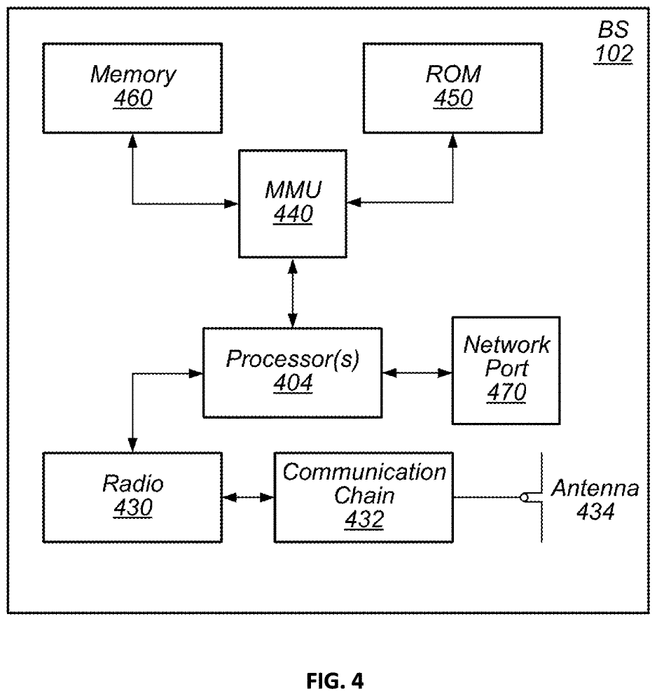

FIG. 4 illustrates an example block diagram of a base station 102, according to some aspects. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, e.g., a 5G New Radio (5G NR) base station, or “gNB”. In such aspects, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs. In some aspects, the base station can operate in 5G NR-U mode.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, 5G NR-U, LTE, LTE-A, GSM, UMTS, CDMA 2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR and 5G NR-U. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA 2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

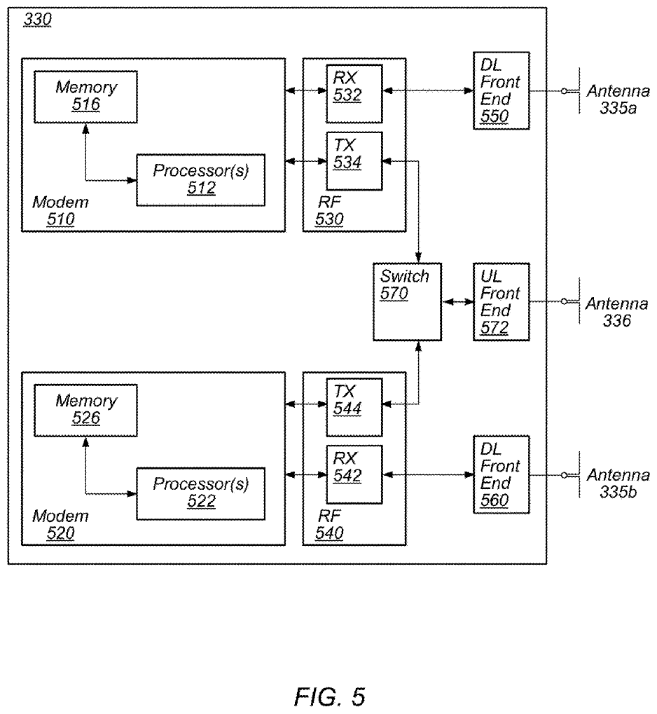

FIG. 5 illustrates an example simplified block diagram of cellular communication circuitry, according to some aspects. It is noted that the block diagram of the cellular communication circuitry of FIG. 5 is only one example of a possible cellular communication circuit. According to aspects, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown (in FIG. 3). In some aspects, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some aspects, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some aspects, receive circuitry 542 may be in communication with DL front end 560, which may include circuitry for receiving radio signals via antenna 335b.

In some aspects, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for determining a physical downlink shared channel scheduling resource for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for determining a physical downlink shared channel scheduling resource for a user equipment device and a base station, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

5G supports multi-antenna transmission, beam-forming, and simultaneous transmission from multiple geographically separates sites. Channels of different antenna ports that are relevant for a UE may differ, for example, in terms of radio channel properties. QCL antenna port may be geographically separated.

5G physical channels provide flexible communication between the 5G base stations and the UEs. 5G NR has specified the physical channels for 5G networks that can be used either for Downlink or Uplink communication. 5G NR physical channels used for uplink communication includes the physical uplink shared channel (PUSCH), the physical uplink control channel (PUCCH), and the physical random-access channel (PRACH). Uplink signals such as DM-RS, PT-RS, and SRS are also supported. 5G NR supports the simultaneous transmission on PUSCH and PUCCH. PUSCH is typically used to carry the user data and optionally, can carry uplink control information (UCI).

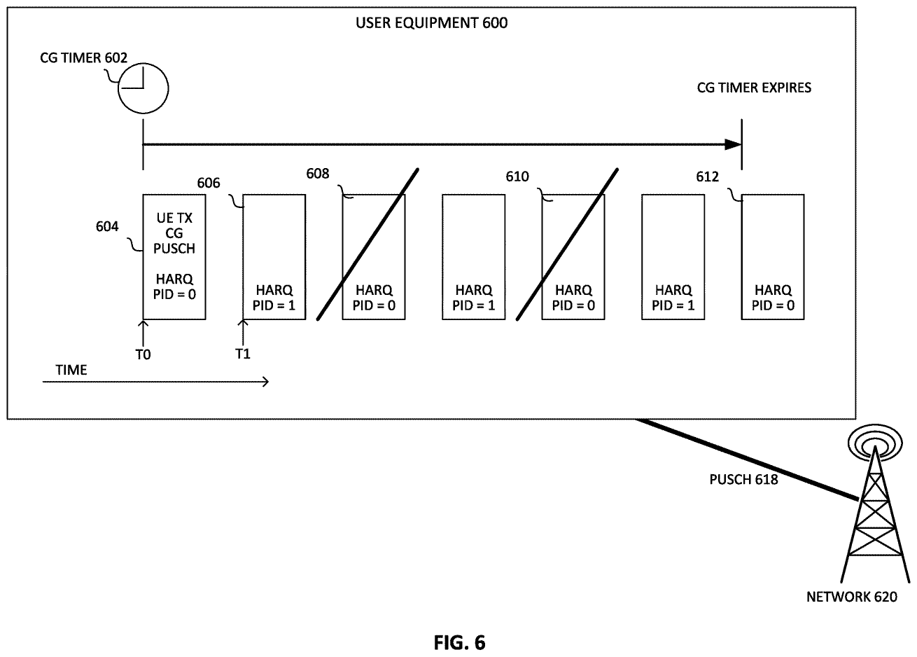

FIG. 6 illustrates a general example of a HARQ process performed by a UE, in accordance with some aspects. The process may be performed by a UE 600, which may correspond to a UE as described in other sections.

5G enabled devices such as UE 600 may implement Hybrid Automatic Repeat Request (HARQ) protocol to communicate on a 5G network (e.g., with the base station 620). A device (e.g., UE 600) that follows HARQ protocols may utilize forward error correction (FEC) and perform automatic retransmission (ARQ). With HARQ, a message may be sent from the network to a UE (or vice versa) with FEC (e.g., extra information for the UE to verify message).

In 5G NR, both downlink and uplink communications may be performed asynchronously using HARQ. HARQ implementation may include simultaneous operation of multiple HARQ processes. To keep track of each HARQ process, the sender (e.g., a UE or the network) and receiver (e.g., the network or the UE) in the HARQ process knows the HARQ process number for each transmission/reception of the HARQ data. For this, downlink control information (DCI) may carry a HARQ process number. Both downlink scheduling DCI (e.g., DCI 1_0, 1_1) and uplink scheduling DCI (e.g., DCI 0_0, 0_1) may carry the HARQ process number, given that both uplink and downlink may implement asynchronous HARQ.

A UE may support up to 16 parallel HARQ processes. Each HARQ process may have a unique identifier (e.g., HARQ ID 0, HARQ ID 1) and dedicated resources (e.g., a buffer) that stores data that is sent by the UE in association with that HARQ process. The HARQ process may be configured to communicate over a given frequency band at given time slots (e.g., periodically). The payload of the message to be sent may be stored by the HARQ process in the dedicated HARQ process buffer, and used to load or reload a transport block that is sent from the UE 600 to the receiver (e.g., the network 620) until the receiver acknowledges that the data with that HARQ process is received and properly decoded (e.g., verified against the FEC). When the HARQ process id is acknowledged by the network 620, the UE may free up and utilize the HARQ process for transmitting new data.

5G physical channels provide flexible communication between the 5G base stations (e.g., network 620) and UEs such as UE 600. 5G NR has specified the physical channels for 5G networks that can be used either for Downlink or Uplink communication. 5G NR physical channels used for uplink communication includes the physical uplink shared channel (PUSCH) 618, the physical uplink control channel (PUCCH, not shown), and the physical random-access channel (PRACH, not shown). Uplink signals such as DM-RS, PT-RS, and SRS are also supported. 5G NR supports the simultaneous transmission on PUSCH 618 and PUCCH. PUSCH is typically used to carry the user data and optionally, can carry uplink control information (UCI).

UE 600 may utilize HARQ protocol and processes to asynchronously send data over PUSCH 618. Network 620 may configure UE 600 statically (e.g., as a configured uplink grant) or dynamically (e.g., a dynamic uplink grant (DG)). A PUSCH message sent by UE 600 based on static configuration may be referred to as a CG PUSCH. A PUSCH message sent by UE 600 based on dynamic configuration may be referred to as a DG PUSCH.

Each PUSCH message, whether statically or dynamically configured, may be associated with a HARQ process ID (PID). A HARQ entity within a UE may manage operation of the processes. A CG configuration may comprise multiple CG PUSCHs with the same HARQ process ID. To send data through a CG PUSCH, the UE may utilize resources of a HARQ process (e.g., a buffer that is dedicated to that HARQ process) by storing data (e.g., a payload) in the HARQ process buffer. The stored data may be copied to a transport block and sent over via the CG PUSCH message asynchronously.

For example, in FIG. 6, at time T0, the UE may start a configured grant (CG) timer 602 when the UE transmits a CG PUSCH message to a receiver (e.g., to network 620) at the periodic occurrence 604 of HARQ process 0. The PUSCH message may start to be transmitted on the first OFDM symbol of the PUSCH. The CG timer 602 is associated with the HARQ PID 0 of the PUSCH.

While the CG timer 602 is running, the UE is blocked from using CG resources with the same HARQ process (e.g., HARQ PID 0). This prevents information (e.g., MAC protocol data unit (PDU)) in the HARQ buffer of HARQ PID 0 from being overwritten by a new transmission. This information (e.g., the stored MAC PDU) may be needed and utilized for HARQ retransmission of HARQ PID 0. CG timer 602 protects the resources of HARQ PID 0 so that the data in the HARQ buffer may be reused for retransmission during the duration of the CG timer.

CG timer 602 may be a software timer that is set to run for a predetermined amount of time. When the CG timer expires, HARQ PID 0 and its resources are available for transmission of new data. For example, at periodic occurrences 608 and 610, HARQ PID 0 is allocated only to multiple periods of the CG associated with HARQ PID 0 until the CG timer 602 expires (or until the HARQ PID 0 is acknowledged). New transmissions cannot utilize HARQ PID 0 at the periodic occurrences 608 and 610 of HARQ PID 0. At periodic occurrence 612, however, a new transmission can utilize HARQ PID 0 to send new data to a receiver (e.g., network 620).

Each HARQ process may have its own resources, its own CG timer, and send its own data in an asynchronous manner and independent of other HARQ processes. For example, at T1, when periodic occurrence 606 of a different HARQ PID 1 occurs, a second CG timer (not shown) may be started to protect the resources of HARQ PID 1. Subsequent periodic occurrences of HARQ PID 1 would be protected (not available for transmission of new data) until that CT timer expired or until HARQ PID 1 is acknowledged by the network 620.

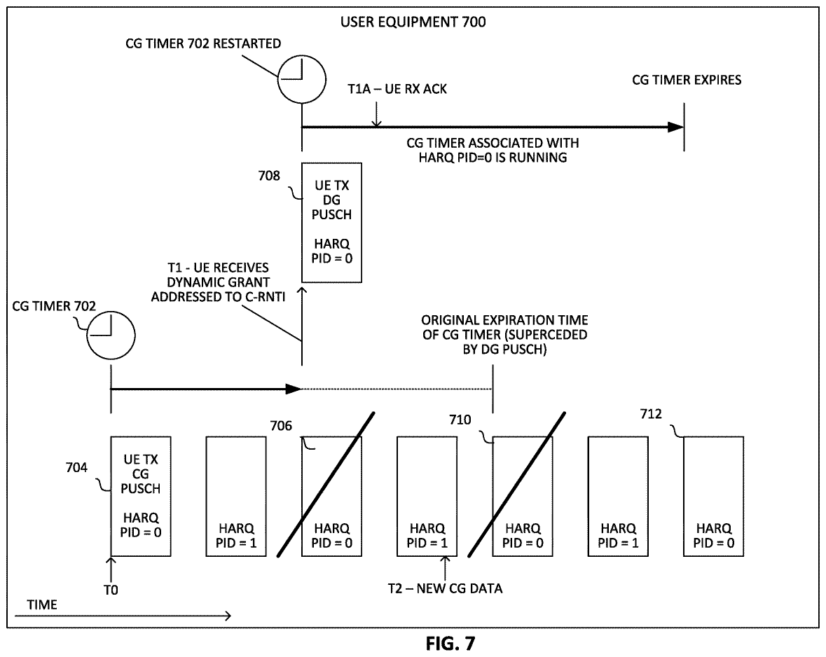

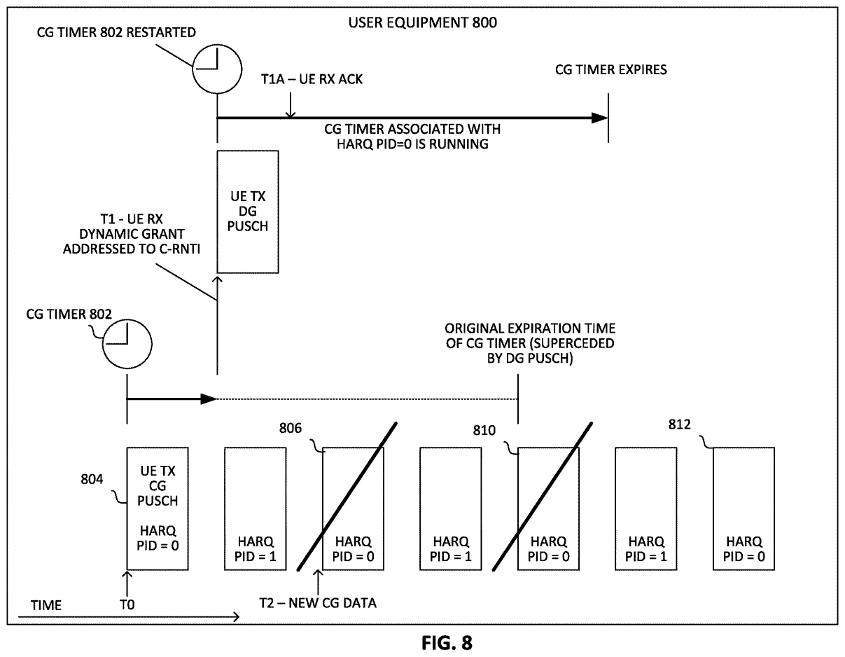

While the CG timer helps protect resources for retransmission (or generally the resources stored in the HARQ buffer), special conditions may challenge the efficiency of this process. For example, under 5G NR, network 620 may dynamically configure UE 600 and messaging over PUSCH (e.g., through a dynamic uplink grant). In response, the UE may immediately commandeer a HARQ process that is allocated to a CG PUSCH and re-allocated it to a DG PUSCH. For example, upon reception of such a dynamic uplink grant, UE 600 may ensure that the previous uplink grant (e.g., a CG) is considered positively acknowledged. As a result, the content of the HARQ process (e.g., its buffer) can be safely overwritten with content for the DG. The UE 600 may start or restart the CG timer 602 to protect the HARQ process from being overwritten by a regular CG while the DG is in progress. Such a scenario is shown and described with respect to FIG. 7 and FIG. 8.

For example, 3GPP TS 38.321V 17.2.0 , section 5.4.1 (UL Grant reception) provides that: Uplink grant is either received dynamically on the PDCCH, in a Random-Access Response, configured semi-persistently by RRC or determined to be associated with the PUSCH resource of MSGA as specified in clause 5.1.2a. The MAC entity shall have an uplink grant to transmit on the UL-SCH. To perform the requested transmissions, the MAC layer receives HARQ information from lower layers. An uplink grant addressed to CS-RNTI with NDI=0 is considered as a configured uplink grant. An uplink grant addressed to CS-RNTI with NDI=1 is considered as a dynamic uplink grant.

If the MAC entity has a C-RNTI, a Temporary C-RNTI, or CS-RNTI, the MAC entity shall for each PDCCH occasion and for each Serving Cell belonging to a TAG that has a running timeAlignmentTimer or a running cg-SDT-TimeAlignmentTimer and for each grant received for this PDCCH occasion:

1> if an uplink grant for this Serving Cell has been received on the PDCCH for the MAC entity's C-RNTI or Temporary C-RNTI; or

1> if an uplink grant has been received in a Random Access Response:

2> if the uplink grant is for MAC entity's C-RNTI and if the previous uplink grant delivered to the HARQ entity for the same HARQ process was either an uplink grant received for the MAC entity's CS-RNTI or a configured uplink grant:

3> consider the NDI to have been toggled for the corresponding HARQ process regardless of the value of the NDI.

2> if the uplink grant is for MAC entity's C-RNTI, and the identified HARQ process is configured for a configured uplink grant:

3> start or restart the configuredGrantTimer for the corresponding HARQ process, if configured;

3> stop the cg-Retransmission Timer for the corresponding HARQ process, if running.

In this disclosure, the nomenclature ‘x>’ where ‘x’ is a number, is used to denote hierarchy in application of logical steps, as also used in 3GPP TS 38.321 and other similar standards.

In such a case where the DG overrides HARQ resources associated with a CG, it may be beneficial to operate the CG timer in a manner that promotes efficient use of HARQ resources.

FIG. 7 shows an example of a HARQ process with a DG override, in accordance with some aspects. As described, a HARQ ID may be allocated by the network dynamically via the DCI for a dynamic uplink grant (DG), or a statically configured grant (CG) may be determined by the UE based on a formula in the MAC spec. In licensed 5G frequencies, HARQ processes may not be shared among different configured grants on the same bandwidth part (BWP). However, HARQ process sharing between dynamic grant (DG) and configured grant (CG) may still happen such that a DG may override a CG using the same HARQ process.

For example, at T0, at period occurrence 704 of HARQ PID 0, the UE 700 may transmit a CG PUSCH to the network (not shown). The UE 700 may start CG timer 702 to restrict access to HARQ PID 0. Under normal conditions, until the CG timer expires or until the CG PUSCH of HARQ PID 0 is positively acknowledged by the network, new transmissions may not utilize HARQ PID 0.

As described, at time T1, the UE may receive (from the network) a dynamic uplink grant (DG) addressed to the cell radio network temporary identifier (C-RNTI) that is associated with the UE 700. C-RNTI is a unique identification used for identifying RRC Connection and scheduling which is dedicated to a particular UE (e.g., UE 700). In response, UE 700 may treat this DG as a signal that the CG PUSCH is positively acknowledged, and start or restart the CG timer 702 for HARQ PID 0. As a result, the UE commandeers HARQ PID 0 to send a data for a DG PUSCH. The DG may specify resources (e.g., use HARQ PID 0 at a given time or time slots, at a given frequency band).

At periodic occurrence 708 of the CG associated with HARQ PID 0 (which is now allocated to the DG PUSCH), the UE 700 may use HARQ PID 0 to transmit a DG PUSCH to a receiver (e.g., the network) and start or restart CG Timer 702 thereby preventing the HARQ PID from being used by new data that arrives for the CG. HARQ PID 0 at occurrence 706 is rightfully blocked from usage by CG because it is being used by the DG. After the CG timer associated with the DG PUSCH expires, HARQ PID 0 at 712 is available.

Assuming, however, that at T2, new CG data is scheduled by the UE to be transmitted, the UE could potentially utilize HARQ PID 0 at occurrence 710, if not for the CG timer 702 being running. The CG timer may prevent new CG data from utilizing HARQ PID 0 even if the DG is successfully sent. As a result, allocation of the HARQ PID 0 to the DG may block the HARQ PID 0 for an unnecessarily long time and create additional delay for the logical channels that are mapped to the CG. At period 712, the logical channels mapped to the CG may make use of HARQ PID 0, because CT Timer 702 (allocated to the DG) has expired, but by this point, some utilization of HARQ PID 0 has unnecessarily been lost. Without additional action by the UE, the DG may unnecessarily block a HARQ process (e.g., HARQ PID 0), even though the DG can retransmit using C-RNTI.

As such, the UE may take further action to improve efficient use of HARQ processes, while understanding that the CG timer needs to run for some duration. Otherwise, another CG could be scheduled by the UE directly after the DG is allocated and overwrite the HARQ process used by the DG.

FIG. 8 shows an example of HARQ processes with a DG override, in accordance with some aspects. FIG. 8 is similar to FIG. 7, except the DG in FIG. 8 is received at an earlier time, and thus, could potentially block access to HARQ PID 0 for a greater time.

At T0, at period 804, UE 800 transmits a CG PUSCH with HARQ PID 0 and restarts CG timer 802 for the DG PUSCH. At T1, the UE receives a DG from the network and transmits a DG PUSCH before the next occasion of the CG HARQ PID 0. Thus, assuming that at T2, new CG data is available for transmission, the UE could potentially utilize HARQ PID 0 at period 806 and period 810 if not for the CG Timer 802 being running. Thus, rather than unnecessarily blocking the HARQ PID 0 for one period (as shown in FIG. 7), here the DG may cause the HARQ process (PID 0) to be blocked for an additional period. After the CG timer associated with the DG PUSCH expires, HARQ PID 0 at 812 is available.

In some aspects, the UE (e.g., UE 700 or UE 800) may stop the CG timer (e.g., 702 or 802) for the HARQ process (PID 0) associated with the DG-PUSCH upon a positive HARQ acknowledgment (e.g., a HARQ-ACK). This allows the next CG (e.g., at period 806) to use the HARQ process PID 0 immediately after the DG is transmitted successfully, assuming the next DG is not conditioned to overrule the CG again.

In some examples, aspects of the disclosure apply to the scenario when the CG timer was initially started by a DG received on the PDCCH for the MAC entity's C-RNTI and a HARQ-ACK is received for the dynamic grant. Since the CG timer was initiated to protect the HARQ process from being overwritten by a different MAC PDU (e.g., for the CG) while the DG is in progress, it is unnecessary (and reduces utilization of resources) to continue running the CG timer when the DG has received a positive acknowledgement.

For example, at TIA, the UA may receive a HARQ-ACK (e.g., through PDCCH for the MAC entity's C-RNTI that corresponds to the UE 700 or 800). The CG Timer (702 or 802) may be stopped to make HARQ PID O available to logical channels allocated to the CG.

In some aspects, a HARQ-ACK for the dynamic grant is received when the NDI provided in the associated HARQ information (e.g., in DCI) has been toggled compared to the value in the previous transmission of the transport block of the HARQ process. At the MAC layer, NDI may be used by the network and UE to determine if a received transport block is a new transmission or a retransmission. When NDI is toggled in DCI, the UE may treat this as an indication that new downlink data is to be received. Similarly, receiving a toggled NDI in uplink grant informs UE to send new data.

In some aspects, if a HARQ process receives downlink feedback information, or if the previous uplink grant delivered to the HARQ entity for the same HARQ process was for the MAC entity's C-RNTI and the identified HARQ process is configured for a configured uplink grant and the HARQ process receives HARQ feedback for the transmission associated with the C-RNTI, the HARQ process shall:

stop the cg-Retransmission Timer, if running;

1> if acknowledgement is indicated:

2> stop the configuredGrantTimer, if running.

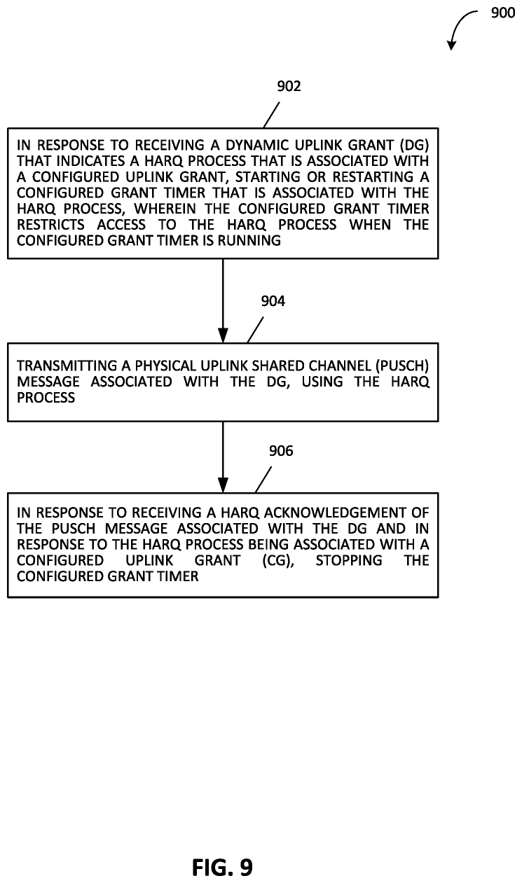

FIG. 9 shows an example of a method for management of a HARQ process in view of a DG override, in accordance with some aspects. The method 900 may be performed by user equipment (UE) in a 5G new radio (NR) environment.

At block 902, the UE may, in response to receiving a dynamic uplink grant (DG) that indicates a HARQ process that is associated with a configured uplink grant, start or restart a configured grant (CG) timer that is associated with the HARQ process, wherein the configured grant timer restricts access to the HARQ process when the configured grant timer is running. For example, as described with respect to FIG. 7 and FIG. 8, the UE may restart CG timer 702 or 802 associated with HARQ PID 0, in response to receiving a DG that indicates HARQ PID 0. While the CG timer is running, the CG timer restricts access of the HARQ PID 0 to logical channels that are associated with the CG.

At block 904, the UE may transmit a physical uplink shared channel (PUSCH) message associated with the DG, using the HARQ process. For example, referring to FIG. 7 and FIG. 8, the UE may transmit a DG PUSCH using HARQ PID 0.

At block 906, the UE may, in response to receiving a HARQ acknowledgement of the PUSCH message associated with the DG and in response to the HARQ process being associated with a configured uplink grant (CG), stop the configured grant timer. For example, referring to FIG. 7 and FIG. 8, at TIA, the UE may receive a HARQ acknowledgement and stop the CG Timer 702 or 802, thereby making HARQ PID 0 available for new CG data transmissions.

In some examples, if the HARQ acknowledgement of the PUSCH message associated with the DG is not received, the configured grant timer is not stopped. For example, referring to FIG. 7 or FIG. 8, if the UE does not receive a HARQ ACK to the DG PUSCH, the UE may allow the CG timer 702 or 802 to run its course (thereby blocking access to HARQ PID 0) until expiration of the CG timer.

The HARQ process may be one of a plurality of HARQ processes, each of the plurality of HARQ processes having a respective buffer used to transmit data associated with the HARQ process, asynchronously. As described, under 5G NR protocol, a UE may manage up to 16 HARQ processes simultaneously. Each of those HARQ processes may include respective resources (e.g., a buffer, a CG timer, etc.) that may be used to send data asynchronously to a receiver. When the CG timer that is associated with a HARQ process is running, the HARQ process (and its buffer) are protected from being overwritten and repurposed for new data. As such, the MAC PDU information associated with the HARQ process is not overwritten with new MAC PDU information for the new data.

In some examples, the UE may transmit new data through a CG PUSCH message with the HARQ process and restart the configured grant timer. For example, in FIG. 7 and FIG. 8, after the UE receives the HARQ acknowledgement and stops the CG timer 702 or 802 at TIA, the UE may, at 710, 806, or 810, utilize the HARQ PID 0 to send new data to a receiver via CG PUSCH. The UE may start the CG timer associated with HARQ PID O to limit access to HARQ PID 0.

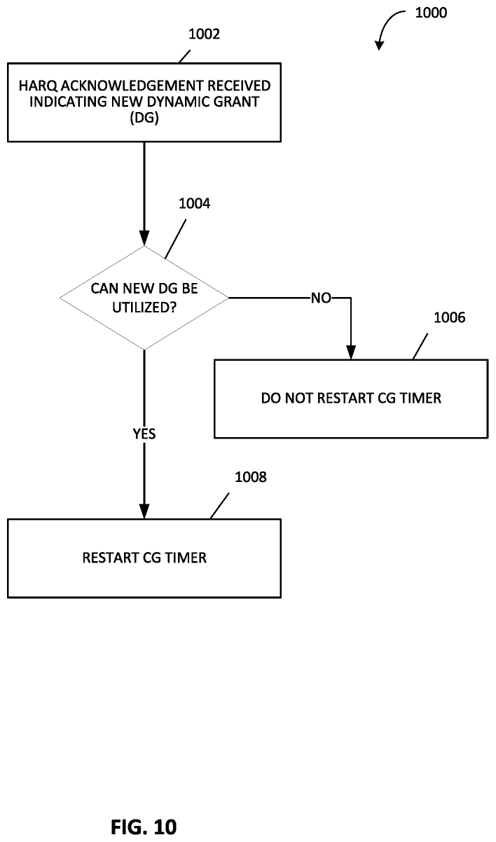

FIG. 10 shows an example workflow 1000 of a HARQ process and new data indication, in accordance with some aspects. In some circumstances, stopping the CG timer in response to a HARQ-ACK to DG PUSCH may not, by itself, be sufficient to make the HARQ process available.

As described, a HARQ-ACK for a DG may be sent by the network as a toggled NDI bit or field. The NDI may be a DCI field within a new DG. If the NDI has been toggled, this may indicate that a DG is received for new data. In such cases, the UE may proceed to perform new transmission on this new DG, which includes restarting the CG timer to protect the HARQ process for the DG PUSCH. In such a case, the HARQ process is still unavailable to logical channels associated with CG.

It is appreciated that the UE could multiplex new data for the CG into the DG, if the logical channels mapped to the CG are also mapped to the DG. In some cases, the next DG (for the same HARQ process) may not be eligible to be used according to logical channel prioritization (LCP) mapping restrictions. Further, in some cases, data may not be available to be multiplexed. For example, the allowed PHY-PriorityIndex may be set to p0 while the DG is for p1 and there are no logical channels (LCHs) allowed to use such DG or there are no LCHs with data available for p1.

The MAC layer prioritizes data from the logical channels CCCH, DCCH, and DTCH. Prioritization of uplink data at the UE may be set based on parameters provided by the network. The parameters may be set through a Logical Channel Config, which may include priority, prioritizedBitRate, and bucketSizeDuration (a low numerical priority corresponds to a high priority). RRC may additionally control the LCP procedure by configuring mapping restrictions for each logical channel, through control of fields including allowedSCS-List, which sets the allowed Subcarrier Spacing(s) for transmission; maxPUSCH-Duration, which sets the maximum PUSCH duration allowed for transmission; configuredGrantType1 Allowed, which sets whether a configured grant Type 1 can be used for transmission; allowedServingCells which sets the allowed cell(s) for transmission; allowedCG-List which sets the allowed configured grant(s) for transmission; and allowedPHY-PriorityIndex which sets the allowed PHY priority index(es) of a dynamic grant for transmission.

In some aspects, the UE may stop the CG timer upon HARQ-ACK for a DG. Additionally, or alternatively, the UE may not start the CG timer again upon a new DG, depending on one or more conditions (e.g., utilization criteria). Additionally, or alternatively, the UE may not start the CG timer if a DG cannot be used (e.g., based on utilization criteria). Each of these behavior options may apply under the one or more conditions such as, for example: LCP mapping restrictions (according to TS 38.321 sub-clause 5.4.3.1.2) prevent to utilize the DG; and/or the logical channels mapped to the CG cannot be multiplexed on the DG; and/or there is no data available for the LCHs mapped to the DG; and/or there is no data available for the LCHs mapped to the CG that is also eligible to be mapped to the DG. The various scenarios are described with respect to the flow diagram shown in FIG. 10.

At block 1002, the UE may receive a HARQ acknowledgement (ACK) from the network which acknowledges receiving a DG PUSCH and indicates a potential new DG with a HARQ process. This HARQ ACK may correspond to the HARQ ACK of block 906 of FIG. 9. As described, the HARQ ACK may be indicated through a toggled value of the NDI field of a DCI. Given that the NDI field serves as both an acknowledgement of the DG PUSCH, and an indication for the UE to send a new DG, it may be desirable to restart the CG timer of the HARQ process associated with the DG PUSCH, to reserve the HARQ process for the new DG transmission.

At block 1004, the UE may determine if a new DG can be utilized by the HARQ process. In some aspects, in response to receiving the HARQ acknowledgement as a toggled new data indication, the UE may proceed to block 1008 and restart the CG timer for the HARQ process in response to determining that the new DG satisfies one or more utilization criteria. The UE may proceed to block 1006 and not restart the configured grant timer for the HARQ process in response to determining that the new DG does not satisfy the one or more utilization criteria of the new DG.

For example, the one or more utilization criteria may be satisfied in response to satisfying logical channel prioritization (LCP) mapping restrictions of the new DG. These LCP mapping restrictions may include those described in 5.4.3.1.2 of TS 38.321, such as, for example, the set of allowed Subcarrier Spacing index values in allowedSCS-List, if configured, includes the Subcarrier Spacing index associated to the UL grant; and maxPUSCH-Duration, if configured, is larger than or equal to the PUSCH transmission duration associated to the UL grant; and configuredGrantType1 Allowed, if configured, is set to true in case the UL grant is a Configured Grant Type 1; and allowedServingCells, if configured, includes the Cell information associated to the UL grant. Does not apply to logical channels associated with a DRB configured with PDCP duplication within the same MAC entity (i.e. CA duplication) when CA duplication is deactivated for this DRB in this MAC entity; and allowedCG-List, if configured, includes the configured grant index associated to the UL grant; and allowedPHY-PriorityIndex, if configured, includes the priority index (as specified in clause 9 of TS 38.213 [6]) associated to the dynamic UL grant; and allowedHARQ-mode, if configured, includes the uplinkHARQ-mode for the HARQ process associated to the UL grant.

In some aspects, at block 1004, the one or more utilization criteria is satisfied in response to logical channels associated with the CG being capable of being multiplexed on the new DG.

In some examples, at block 1004, the one or more utilization criteria is satisfied in response to data being available for one or more logical channels that are mapped to the new DG or that are mapped to the CG wherein the data is eligible to be mapped to the new DG.

In some aspects, if the MAC entity has a C-RNTI, a Temporary C-RNTI, or CS-RNTI, the MAC entity shall for each PDCCH occasion and for each Serving Cell belonging to a TAG that has a running timeAlignmentTimer or a running cg-SDT-TimeAlignmentTimer and for each grant received for this PDCCH occasion:

if an uplink grant for this Serving Cell has been received on the PDCCH for the MAC entity's C-RNTI or Temporary C-RNTI; or

if an uplink grant has been received in a Random Access Response: if the uplink grant is for MAC entity's C-RNTI and if the previous uplink grant delivered to the HARQ entity for the same HARQ process was either an uplink grant received for the MAC entity's CS-RNTI or a configured uplink grant: consider the NDI to have been toggled for the corresponding HARQ process regardless of the value of the NDI.

if the uplink grant is for MAC entity's C-RNTI, and the identified HARQ process is configured for a configured uplink grant: if the logical channels that have data available that can be multiplexed in the MAC PDU can be transmitted on the uplink grant according to mapping restrictions (e.g., as described in clause 5.4.3.1.2 of 3GPP TS 38.321 V17.2.0), start or restart the configuredGrantTimer for the corresponding HARQ process, if configured; stop the cg-RetransmissionTimer for the corresponding HARQ process, if running.

With aspects described in the present disclosure, the latency for SDUs transmitted on a logical channel mapped to the CG can be reduced. Further, power consumption may be reduced, as the UE may complete outstanding CG transmissions faster. The UE may use the spectrum more efficiently. Aspects described may apply to legacy NR MAC (e.g., in Rel-16 and Rel-17) and/or for URLLC/IIoT.

It should be understood that examples and aspects of the present disclosure can be combined by one skilled in the art.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMS, EEPROMs, magnetic or optical cards, or any type of media suitable for storing electronic instructions, and each coupled to a computer system bus.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

A baseband processor (also known as baseband radio processor, BP, or BBP) is a device (a chip or part of a chip) in a network interface that manages radio functions, such as communicating (e.g., TX and RX) over an antenna.

An article of manufacture may be used to store program code. An article of manufacture that stores program code may be embodied as, but is not limited to, one or more memories (e.g., one or more flash memories, random access memories (static, dynamic, or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary aspects of the present invention. One skilled in the art will readily recognize from such discussion, the accompanying drawings and the claims that various modifications can be made without departing from the spirit and scope of the invention.

1. A method performed by user equipment (UE) in a 5G new radio (NR) environment, comprising:
in response to receiving a dynamic uplink grant (DG) that indicates a HARQ process that is associated with a configured uplink grant, starting or restarting a configured grant timer that is associated with the HARQ process, wherein the configured grant timer restricts access to the HARQ process when the configured grant timer is running;
transmitting a physical uplink shared channel (PUSCH) message associated with the DG, using the HARQ process; and
in response to receiving a HARQ acknowledgement of the PUSCH message associated with the DG and in response to the HARQ process being associated with a configured uplink grant (CG), stopping the configured grant timer.

2. The method of claim 1, wherein in response to receiving the HARQ acknowledgement as a toggled new data indication, restarting the configured grant timer for the HARQ process in response to determining that a new DG satisfies one or more utilization criteria, and not restarting the configured grant timer for the HARQ process in response to determining that the new DG does not satisfy the one or more utilization criteria of the new DG.

3. The method of claim 2, wherein the one or more utilization criteria is satisfied in response to satisfying logical channel prioritization (LCP) mapping restrictions of the new DG.

4. The method of claim 2, wherein the one or more utilization criteria is satisfied in response to logical channels associated with the CG being capable of being multiplexed on the new DG.

5. The method of claim 2, wherein the one or more utilization criteria is satisfied in response to data being available for one or more logical channels that are mapped to the new DG.

6. The method of claim 2, wherein the one or more utilization criteria is satisfied in response to data being available for one or more logical channels that are mapped to the CG wherein the data is eligible to be mapped to the new DG.

7. The method of claim 1, wherein if the HARQ acknowledgement of the PUSCH message associated with the DG is not received, the configured grant timer is not stopped.

8. The method of claim 1, wherein the HARQ process is one of a plurality of HARQ processes, each of the plurality of HARQ processes having a respective buffer used to transmit data associated with the HARQ process, asynchronously.

9. The method of claim 1, wherein the configured grant timer prevents the HARQ process from being repurposed and overwritten for new data.

10. The method of claim 1, further comprising transmitting new data through a CG PUSCH message with the HARQ process and restarting the configured grant timer.

11. A user equipment (UE), having a processor that is configured to perform operations comprising:
in response to receiving a dynamic uplink grant (DG) that indicates a HARQ process that is associated with a configured uplink grant, starting or restarting a configured grant timer that is associated with the HARQ process, wherein the configured grant timer restricts access to the HARQ process when the configured grant timer is running;
transmitting a physical uplink shared channel (PUSCH) message associated with the DG, using the HARQ process; and
in response to receiving a HARQ acknowledgement of the PUSCH message associated with the DG and in response to the HARQ process being associated with a configured uplink grant (CG), stopping the configured grant timer.

12. The UE of claim 11, wherein in response to receiving the HARQ acknowledgement as a toggled new data indication, restarting the configured grant timer for the HARQ process in response to determining that a new DG satisfies one or more utilization criteria, and not restarting the configured grant timer for the HARQ process in response to determining that the new DG does not satisfy the one or more utilization criteria of the new DG.

13. The UE of claim 12, wherein the one or more utilization criteria is satisfied in response to satisfying logical channel prioritization (LCP) mapping restrictions of the new DG.

14. The UE of claim 12, wherein the one or more utilization criteria is satisfied in response to logical channels associated with the CG being capable of being multiplexed on the new DG.

15. The UE of claim 12, wherein the one or more utilization criteria is satisfied in response to data being available for one or more logical channels that are mapped to the new DG.

16. The UE of claim 12, wherein the one or more utilization criteria is satisfied in response to data being available for one or more logical channels that are mapped to the CG wherein the data is eligible to be mapped to the new DG.

17. The UE of claim 11, wherein if the HARQ acknowledgement of the PUSCH message associated with the DG is not received, the configured grant timer is not stopped.

18. The UE of claim 11, wherein the HARQ process is one of a plurality of HARQ processes, each of the plurality of HARQ processes having a respective buffer used to transmit data associated with the HARQ process, asynchronously.

19. The UE of claim 11, wherein the configured grant timer prevents the HARQ process from being repurposed and overwritten for new data.

20. The UE of claim 11, further comprising transmitting new data through a CG PUSCH message with the HARQ process and restarting the configured grant timer.
